(19) United States
(12) Patent Application Publication
(10) Pub. No.: US 2019/0041518 A1
(43) Pub. Date: Feb. 7, 2019

(54) DEVICE AND METHOD OF OPTICAL RANGE IMAGING

(71) Applicant: Oyla Inc., Palo Alto, CA (US)

(72) Inventors: Ralph Spickermann, Redwood City, CA (US); Srinath Kalluri, Palo Alrto, CA (US)

(73) Assignee: Oyla Inc., Palo Alto, CA (US)

(21) Appl. No.: 16/054,722

(22) Filed: Aug. 3, 2018

Related U.S. Application Data
(60) Provisional application No. 62/541,680, filed on Aug. 5, 2017.

(51) Int. Cl. G01S 17/89; G06T 7/521; G01S 17/08; G01S 17/93

(52) U.S. Cl. CPC G01S 17/89; G06T 7/521; G06T 2207/10028; G01S 17/93; G01S 17/08

(57) ABSTRACT

An optical device creates a 3D image of a volume of interest comprising horizontal, vertical, and distance information for each voxel. Two pairs of two Risley prisms rotate synchronously to first create outgoing modulated illumination beams, and second to direct incoming light to an image sensor. Synchronization allows the imaging portion of the system to look at the same field of view as is illuminated. This field of view is smaller than the volume of interest. The field of view is scanned both horizontal and vertically to encompass the volume of interest, and may by directed to any arbitrary field of view. The illumination beam is amplitude modulated. The image sensor demodulates synchronously, computing time-of-flight for each pixel. Modulation frequency and sensor integration time are dynamically adjusted responsive to a desired volume of interest or field of view.

This application claims priority to and benefit of U.S. provisional application number 62/541,680, filed Aug. 5, 2017, with first named inventor Ralph Spickermann.

### FIELD OF THE INVENTION

This invention is in the field or optical image ranging devices, such as LIDAR.

### BACKGROUND OF THE INVENTION

Devices such as LIDAR are useful for autonomous vehicles and other applications to create a three-dimensional (3D) representation of elements within a volume of space around the device. The three dimensions are nominally horizontal, vertical, and distance. Prior art automotive LIDARs use parallel laser beams and spinning optics. They are expensive, slow, bulky and unreliable. Prior art consumer devices, such as Microsoft® Kinect® create 3D image. However, they are limited both by maximum distance and a limited field of view.

An additional weakness of the prior art is that the devices may not be arbitrary directed at a region of interest smaller than the full scanned volume, or that a tradeoff between two parameters may not be dynamically selected.

Yet another weakness of the prior art is performance is limited when eye-safe conditions are required.

Additional weakness of the prior art include low reliability and high maintenance of laser-based imaging devices and devices that use large rotating components. Yet another weakness is high cost.

### SUMMARY OF THE INVENTION

This invention overcomes the weaknesses of the prior art.

In an exemplary embodiment, device creates a 3D image of a volume of interest comprising horizontal, vertical, and distance information for each voxel. Two pairs of two Risley prisms rotate synchronously to first create outgoing modulated illumination beams, and second to direct incoming light to a 2D pixel-array image sensor with time-of-flight, such as 320×240 pixels or larger. Synchronization allows the imaging portion of the device to look at the same field of view as is illuminated. A particular field of view is smaller than the volume of interest, and thus we refer to them as “reduced fields of view.” The volume of interest is scanned both horizontal and vertically with multiple reduced fields of view. A reduced field of view may arbitrarily be directed to any part of the total volume of interest. The illumination beam is amplitude modulated. The image sensor demodulates synchronously, computing time of flight for each pixel. Modulation frequency and sensor integration time are dynamically adjusted responsive to a desired volume of interest or field of view.

An outgoing illumination beam may be visible or IR, and is typically amplitude modulated with a square or sine wave. A pixel-array image sensor, on a per-pixel or per-pixel-block region uses a quadrature demodulator, or “phase detector” that is synchronous with the modulation. In this way, each pixel or pixel block senses, ideally, only the reflected light from the illumination beam. The synchronous detection implements the time of flight (ToF) aspect of reflected light.

### BRIEF DESCRIPTION OF THE DRAWINGS

FIG. 1 shows an exemplary mechanical view of an embodiment of the invention.

FIG. 2 shows a schematic of elements showing light paths.

FIG. 3 shows reduced fields of view within a total field of view.

### DETAILED DESCRIPTION OF THE INVENTION

Exemplary, non-limiting embodiments are described below. All figures show exemplary, non-limiting embodiments.

The goal of the invention is to create a data set comprising a “3D point cloud,” where each point comprises X and Y locations (or azimuth and elevation angles) and a distance. In combination with a known location and angles of the device, this allows a complete six-axis determination for each point. Generally each point is associated with a

point on a physical object. Such devices are frequently referred to as a, “LIDAR.” However, modern devices may not use a laser (the “L” in LIDAR) as a light source, Devices use a scanning mechanism, either directly or indirectly, to scan a desired field of view (FoV). The field of view typically comprises scanning in both an X FoV and a Y FoV, often expressed as an angle, such as 90° horizontal (X, typically) and 15° vertical (Y, typically). Note that linear units (e.g., X and Y) are frequently used in conjunction with angle units (azimuth and elevation). Sometimes scanning is done only on one axis, such as X or Y only. A key aspect of LIDAR and similar optical ranging devices is that they use “time of flight” (ToF) to determine distance of the point from the device. Light is emitted by the device (or controlled by the device), and then the reflected light from the point on the object is timed with respect to the emission. A distance between the device and a point is often called a, “range.”

Prior art typically uses a fixed field of view. Prior art typically uses rotating optics, which cannot be dynamically changed to adjust either a horizontal or vertical field of view. The spacing of points in the point cloud is usually expressed as either a resolution angle, such as 0.15°; or as distances, such as 10 cm spacing at a distance of 15 meters. Prior art does not permit dynamic changing of resolution. Another metric of devices is scan rate and maximum distance. Typically, one of these may be traded off for the other. However, prior art devices may not make such a tradeoff dynamically. Yet another metric is whether the light emission of the device is, “eye-safe,” which is defined in the ophthalmology art, such as irradiance intensity at the retina.

In one embodiment, synchronous rotation of two pairs of Risley prisms, one pair to bend the transmitted light beam from collimating optics in a desired direction (both azimuth and elevation), the other to capture an image of the illuminated spot on the object (the physical “point”) by bending back the received light towards the imaging device through telescopic optics. The imaging device is a two-dimensional array of pixels composed of photodiodes and special circuitry to compute distance from time of flight calculations. Collimating optics may be considered to be a telescope. In one embodiment, the path of light is: (1) light source; (2) collimator; (3) first pair of Risley prisms; (4) towards the object; (5) reflection off the object; (6) return to the device; (7) a second pair of Risley prisms; (8) receiving optics, such as a telescope; (9) 2D pixel-array image sensor. The terms “collimator” and “telescope” optics may be used interchangeably, in part because the technical scope of these terms overlap. Historically, a “collimator” is used for projection optics; while “telescope” is used for observing optics; such terminology does not necessarily indicate details of the optical device, nor does it indicate by itself the direction of light through the device. The above number portions of the light flow may be divided into the “illumination subsystem,” comprising (1) through (4); and the “imaging subsystem” (or “receiving subsystem”), comprising (6) through (9). Additional optical elements may be in the light path, such as polarizers, spectral filters, polarization filters, diffusers, mirrors, beam-shaming elements, and the like; and calibration elements. Optics may include optical elements to correct or reduce optical aberrations, such as chromatic aberration.

Note that considerable electronics, post-processing and calibration is typically required of a device to implement full functionality.

In one embodiment, rotating the first pair of Risley prisms allows the light beam to be pointed in the desired direction within a sub-region of view within the total field of view. The device may, “scan,” that is, the pointing direction is changed in a continual sequence; or it may select a single desired pointing direction. This ability is novel of the prior art. In addition, both the azimuth and elevation sub-fields of views, within the total field of view, may be selected arbitrarily. In addition, changing “integration time” for each point allows dynamic tradeoffs between scan rate, maximum detectable distance, and point spacing. Generally, the longer the integration time the longer the maximum detectable distance, but also either point spacing must increase or the scan rate must decrease. Similarly, point spacing (closer) and scan rate (faster) are inversely related. “Scanning” may be implemented by continuous movement of the Risley prisms, while arbitrary pointing may be implement by a moving the prisms to desire positions, stopping motion, capturing points, then moving to new positions.

In one embodiment the angular positions of each of the two prisms (the optical “wedges”) in the first pair of Risley prisms are synchronized with the angular position of each of the two prisms in the second pair of Risley prisms. This, in plain English, allows the device to “see” the same field of view, and thus the spot of interest, as is illuminated.

In one embodiment, illumination light is spread over an illumination shape, which may be symmetric: that is, the azimuth and elevation are the same, such as for a circular illumination shape. Or, the illumination shape may be asymmetric, such as an ellipse or rectangle. With spread illumination light, many spots of interest are illuminated simultaneously.

In one embodiment, reflected light from objects in the illumination shape is received simultaneously by all pixels, or pixel group, in a 2D pixel-array image sensor chip, with time-flight recorded for each pixel or pixel group individually.

In one embodiment, the pair of Risley prisms may be rotated to desired positions, and then stopped. A sub-region of interest is illuminated simultaneously by the illumination subsystem. This sub-region of interest is then imaged in parallel by pixel-array image sensor. For example, a sensor with 320×240 pixel array is able to image 76,800 points simultaneously. It is often desirable to use adjacent pixels in combination to increase light sensitive and maximum distance, at the expense of fewer simultaneous spot detections. In one embodiment, the selection of how many effective pixels are used per point is selectable dynamically.

In one embodiment, the illumination light is modulated, such as intensity modulated with a sine wave, square wave, or pulse, or another repeating wave shape, at a modulation frequency. The received light is detected using a synchronized quadrature detector, such as by sampling the intensity of the receive light four times per cycle of the modulation frequency. This permits ambient light intensity to be removed from the computed (via analog or digital, electronic or software) receive intensity associated with the spot. Sampling may be more often than four times per modulation cycle. Typically, illumination spectral bandwidth is narrow so as to reduce the total received power of ambient light, such as sunlight or artificial illumination sources.

The pixels in image sensor chips typically operate in two alternating phases. During the phase, light is collected. This the “integration” time, and may roughly be thought of as a shutter speed. The second phase is “read out,” which comprises both reading the accumulated charge (or other physical parameter of the pixels in the sensor) in each pixel, and also reading out of the sensor that data. Data quantity from the sensor can be quite high, so read-out time may be significant. If integration time and read-out time are the same, which they often are not, then one might think of the chip as sensing only 50% of the time.

In one embodiment, the pixel array in a sensor is divided into sub-arrays. The sub-arrays may have some attributes independent of other sub-arrays. For example, on sub-array may be integrating while another sub-array is reading out. In one embodiment, the use of such sub-arrays is alternated, so that one group (one or more) of sub-arrays is integrating while another group is reading out. One advantage of the embodiment is that read-out may be continuous, rather than start-stop.

In one embodiment, the modulation frequency is varied. Devices have a potential problem in that spots that are farther away than the maximum distance may reflect light that is received in the next cycle, producing artifacts. Such artifacts shift with a change in modulation frequency, but determined valid distances (within the maximum distance) will not shift. Therefore, multiple modulation frequencies can be used to identify and then remove such artifacts. Such modulation frequency shifts may be done slowly, such as one per complete field of view scan, or quickly.

Detection of a distance to an object of interest suffers from potential ambiguity because the object may be farther away than the time of flight of one cycle of the modulation frequency. In yet another embodiment, an optical camera, looking at the same object of interest, in one or multiple reduced fields of view, may be used to disambiguate distance to the object, using, for example, stereo imaging, or object recognition, such as using the apparent size of a recognized vehicle or stop sign. In plain English, the optical camera may determine a coarse distance and an embodiment the ranging device a fine distance.

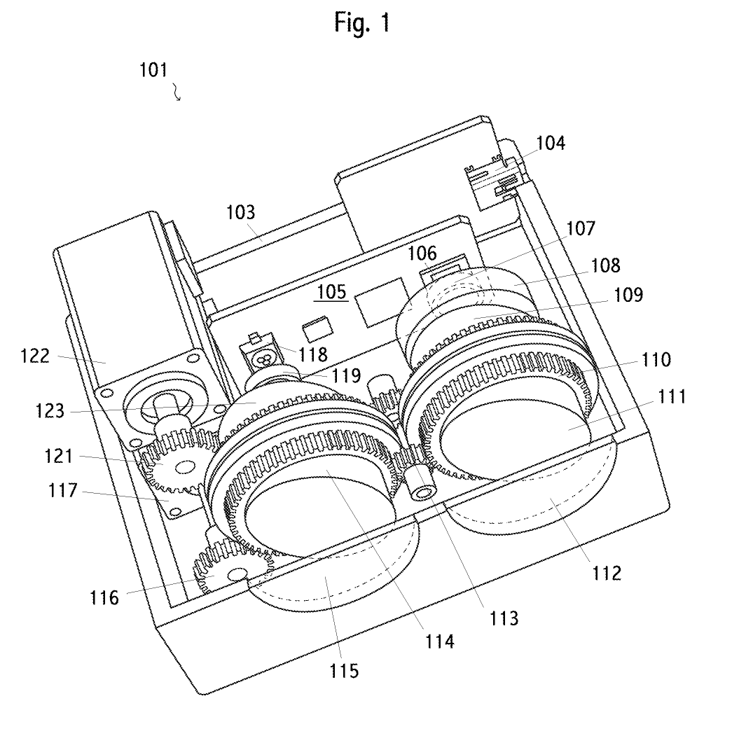

Turning to now FIG. 1, we see an exemplary mechanical view of one embodiment, 101. A case for the device is 103. 122 is a first prism motor to operate one degree of freedom of at least one pair of Risley prisms. It is operatively connected by gears such as 121 or any other drive mechanism (capstans, belts, chains, worm gears, magnetic coupling, inductive coupling, capacitive coupling, and the like) to rotate a respective first prism, 123. A second prism motor 117 is operatively connected to drive a second degree of freedom of the at least one pair of Risley prisms: rotating a second, associated prism 114. Note that usage of “Risley prism” herein is for each wedge within a pair of Risley prisms. For example, 123 and 114 make up such a pair and 109 and 111 make up a second pair.

The two pairs of Risley prisms are kept synchronized via two or more connecting gears 113, or other drive devices, such as discussed above, to operatively connect to the a prism in the second pair of Risley prisms. Another embodiment uses separate motors, such as a total of four motors, one per wedge. Prism motors 122 and 117 may be any type of motor, including stepper motors, servo motors, linear motors, hydraulic motors and the like. The motors may operate open loop or have position feedback to operate closed loop. Sensors for closed loop control may be associated with any moving element from the motor through the prism, or may be driven by an additional element, such as connecting gear, gear, capstan, or optical or magnetic coupling. Such sensors are not shown in this Figure.

It is convenient, although somewhat arbitrary, to consider two subsystems: an illumination subsystem and an imaging subsystem. The illumination subsystem provides modulated continuous wave light from the device towards a distant scene, typically comprising one or more objects. The object reflects light back to the device, which passes through the imaging subsystem.

In the embodiment shown in the Figure, a continuous wave light source 118 is modulated by a modulator, which might be mounted on circuit board 105. A modulator may be associated with, or part of, the light source 118, or may be external to the device, in which case the device is adapted or configured to accept an external modulator or modulation signal. Modulation might be amplitude modulation by a sine wave, a square wave, a pulse, or another continuous waveform. In another embodiment, modulation is frequency modulation, or both amplitude and frequency modulation. In yet another embodiment, modulation is polarization angle. Modulation frequency may be fixed or dynamically selectable, such as programmable. In the Figure light source 118 is shown as multiple LEDs mount on a circuit board 105, although mounting details and locations are design choices. Alternative light sources include lasers, which may be semiconductor or solid, gas or liquid lasers. Light may be coherent or non-coherent. Alternatively, the device may be adapted or configured to accept external light, which may be modulated or not modulated external to the device. Exemplary wavelengths are 600, 850, 904, 940 and 1550 nanometers (nm). Frequencies may be in the visible light bands, ultraviolet, deep infrared, thermal frequencies or radio frequencies.

Light from the modulated, continuous wave light source 118 typically passes through a collimator 118 and optionally a beam spreader, not shown. However, these elements are optional, depending on the embodiment. Ideally, light also passes through a band-pass optical filter, which may be anywhere in the illumination light path. The optical filter may alternatively be a low-pass or high-pass filter, depending in part on the nature of the light source 118, spectral responsiveness of the imaging subsystem, or other embodiment variations. Spectral filters may be coatings on another optical element, including on any surface of the Risley prisms.

Yet another optional optical element is an engineered diffuser, or diffraction grating, for the purpose of creating a preferred beam spread or beam shape. For example, it may be desirable to have a “top hat” shape compared to a Gaussian shape. Alternatively, a non-symmetric shape such as elliptical, rectangular or a line may be desirable, particularly to minimize motion blur caused by either motion of an object being imaged or motion of the device itself, or motion with respect to scanning.

As light exits the pair of illumination Risley prisms, at 114, it optionally passes through a window 115 in the enclosure 103. The window 115 may be for the purpose of keeping the components of the device clean; it also may be an optical component as discusses elsewhere herein, including a spectral filter, a diffuser, an aperture lens, or beam spreader. An engineer diffuser, such as 115 provides a precise beam spread, such as 5° or in the range of 0.1° to 45°.

The pair of illumination Risley prisms, 123 and 114, are dynamically oriented to select an arbitrary reduced field of view. The operative range of the pair of illumination Risley prisms, 123 and 114 makes up a total field of view of the illumination subsystem. The reduced fields of view may be arranged in a grid, often represented as an X (e.g., horizontal) and Y (e.g., vertical). However, it is technically more proper to refer to angles, such as azimuth and elevation, which may be absolute angles or angles relative to the device as a whole.

Since the illumination light in embodiments does not strike an object as a point (or diffraction limited spot), but rather has a spread, it is appropriate to discuss either a beam spread angle, such as 0.05°, or a solid angle, such as 0.00001 steradians. The beam may be asymmetric, in which case it may be appropriate to both a horizontal and vertical beam spread. Ideally, both the illumination field of view and the imaging field of view are exactly square. Ideally, too, the illumination field of view as perfectly uniform (“flat”) illumination. In addition, the various reduced fields of view alight at their borders perfectly. However, no such precision is available for real-world devices and any discussion or descriptions herein, including also drawings, claims and abstract, assume such practical variations, independent of words used, such as, “matching,” “replicated,” “aligned,” “contiguous,” and the like.

Light reflected from objects in a reduced field of view re-enters the device into the imaging subsystem. It first passes through an optional window 112 in the enclosure 103. The window 112 may be for the purpose of keeping the components of the device clean; it also may be an optical component as discusses elsewhere herein, including a spectral filter, focus lens, or other optical element. The pair of Risley prisms 111 and 109 are oriented so that the reduced field of view of the illumination subsystem (in particular, created by the orientation of Risley prisms, 123 and 114) is replicated by the pair of imaging Risley prisms 111 and 109. We say that the illumination pair of Risley prisms is synchronized with the imaging pair of Risley prisms, or similarly that the imaging pair of Risley prisms tracks the illumination pair of Risley prisms, or similarly that the imaging reduced field of view is the same as (or overlaps) the illumination reduced field of view.

There are reasons that the illumination field of view may not be exactly identical to the imaging field of view. For example, the limits of manufacturing tolerance and mechanical drift may put the two reduced fields of view slightly off. As another example, the illumination field of view may intentionally be slightly larger than the imaging field of view (e.g. the solid angle is greater) because the luminous intensity or irradiated power of the illumination light, at an object, may not be perfectly uniform, but may roll off at the edges of the beam. It may be desirable to not image such edges. As yet another example, the illumination field of view may intentionally be slightly smaller than the imaging field of view (e.g. the solid angle is less) so that the edges of the imaged field of view overlap from one reduced field of view to another, or to compensate for less than perfect alignment. Such an arrangement also provides for the ability to measure the alignment of the illumination sub-system with the imaging subsystem. For example, determining if the illumination reduced field of view is “centered” in the imaged field of view. In another embodiment, pixels in the received field of view outside of the illuminated field of view may be used to determine the ambient light bordering the illuminated field of view. Thus, when we say, a same, a similar, a tracking, or a matching field of view, either for a total field of view, or a reduced field of view, we are including the size, shape and matching variations described herein, unless otherwise stated. Features in this paragraph are specifically claimed.

In one embodiment, the two prism drive motors 122 and 117 that control the orientation of the illumination Risley prisms 123 and 114, also control orientation of the imaging Risley prisms 109 and 111. One such coupling embodiment is shown as gears 113. However, other couplings devices may used, such as discussed above. In another embodiment, four motors are used instead of two; one for each Risley prism. Advantages of this embodiment are fewer mechanical parts and less mechanical slop. Also, alignment and calibration may be simplified. Such an embodiment is specifically claimed.

Received light passes through a window 112 in the enclosure 103. Similarly to the illumination window 115, it may be optional or provide optical elements, such as window 115.

Received light then passes through the two imaging Risley prisms 111 and 109, then passes through a focusing lenses 108 and 107 which focuses an image of the reduced field of view onto a pixel-array image sensor 106. Pixels in the pixel-array image sensor (also referred to as, “sensor”) are typically but not always arranged as rectangular grid of rows and columns. Other arrangements may be used, such as a hexagonal grid, or a pattern roughly circular in shape. Pixels are typically square. Other pixels shapes may be used, such as rectangular. Pixel size is typically the same for all pixels. Other pixels size variations may be used, such as larger pixels near the perimeter and smaller pixels near the center (or the reverse). An advantage of rectangular pixels shape is it may more closely match a desired field of view shape, or which might be used to implement a different vertical resolution versus horizontal resolution. An advantage of a hexagonal array is that hexagonal pixels more closely match a more optically natural field of view shape of circular (i.e., conical beam). An advantage of variable pixel size is to be able to trade off resolution with light sensitivity at different portions of a field of view. A higher special resolution near a center of a field of view more closely resembles human eyes. Yet another feature of a pixel-array image sensor, in some embodiments, is the ability to dynamically link adjacent pixels into pixel groups. This can increase sensitivity or improve signal-to-noise ratio (S/N) at the expense of reduced spatial resolution. This may be used to dynamically increase range, which may be used selectively for only some reduced fields of view. Or may be used to change, selectively, range for a single field of view. The number of pixels in a pixel-array image sensor may be in the range of 40 to 40 million, or the range of 100 to 10 million, or the range of 400 to 1 million, or the range of 25,000 to 1 million. In some embodiments, pixels may be arranged in blocks, where each block may have integration times and read-out times controlled independently. This is useful if only a subset of a field of view is desired, which may improve overall device scan speed at the expense of ignoring areas of a total or reduced field of view. That is, in one embodiment, a non-rectangular reduced field of view or total field of view may be selected, such a based on a known or suspected non-rectangular region of interest. Yet another use of such blocks is to overlap, or stagger, integration time with read-out time. Such a feature may be use to dynamically determine a velocity of an object of interest more quickly than repetitive reception of a complete reduced field of view. In yet another embodiment, a pixel or group of pixels may have multiple integration time windows, with no readout in between these time windows. This permits increased sensitivity, improved signal to noise, or improved range at the expense of slower data acquisition (time resolution) for that pixel or group. This is particularly valuable when it is desirable to parse a reduced field of view into FoV “segments” where the tradeoff between sensitive (e.g., range) and data acquisition speed is then dynamically selectable in both time and spatial position. In one embodiment, overlapping reduced fields of view are combined with pixel blocks. For example, consider two overlapping reduced fields of view. Pixel blocks for the overlapping areas have one set of operating parameters, as described herein, while the non-overlapping areas have a different set of operating parameters. Thus, the overlapping areas might then have increased range or increased special resolution. Note that pixel blocks may align with segments of a field of view, but not necessarily.

Received light passes through the two imaging Risley prisms 111 and 109, then passes through a focusing lenses 108 and 107 which focuses an image of the reduced field of view onto a pixel-array image sensor image sensor 106. The pixel-array image sensor also comprises ranging capability, typically by quadrature sampling (e.g., four samples per waveform) received light at each pixel. The modulated signal used to modulate the light source 118 is also used, directly or indirectly, to demodulate the received light at each pixel in the pixel-array image sensor. The exact shape of the demodulation waveform may not be identical to the modulation waveform for numerous reasons. One reason is that the neither the light source 118 nor the receiving pixels in the pixel-array image sensor 106 are perfectly linear; waveforms may be shaped to correct or improve the non-linearities of either the light source 118 or the receiving pixels, or both. Another reason is to raise signal levels above a noise floor. The modulation signal or and the demodulation signal are the same frequency and phase matched. Their phases may not be perfectly identical, intentionally, due to delays both in the electronics and in the optical paths. Such demodulation is typically referred to as synchronous, as known to those in the art. Modulation and demodulation may also be “boxcar,” that is using square waves, where the intensity is nominally binary valued.

Focus lens 108 and 107 or the 2D pixel-array image sensor 106 may also comprise a dynamic focus capability, such as a PZT to adjust position, not shown. Such dynamic focus or alignment elements may be separate, and may be anywhere in either the illumination or imaging optical paths.

The imaging optical path may contain additional optical elements, such as spectral filters, anti-reflective coatings, polarizers, and the like. It may also contain optical elements to correct lens aberrations, such as discussed above.

In addition to the above optical elements, any portion of an optical path may be, “folded,” such as use of mirrors, prisms, beam-splitters and the like. No such elements are shown in this Figure.

In addition to the above optical elements, any portion of an optical path may contain elements for the purpose of alignment, calibration or test. As a non-limiting example, a beam-splitter may be used to inject into or monitor a portion of a light path. An optical path may contain optical aberration correction elements, which may be, for example, active or passive; electronically operative, or piece-wise addressable; monolithic or made of multiple components; and may be separate elements or part of another element, such as an optical coating. Optical aberration correct elements may correct or reduce distortion from focus; flat versus curved field; spherical aberration; coma; astigmatism; field curvature; barrel distortion; pincushion distortion; mustache distortion, or perspective. Ideally, any such spatial distortions are corrected in software, when mapping from individual pixels in the pixel-array image sensor 106 to corresponding physical location of points in the 3D point-cloud. In some embodiments, chromatic aberrations of elements in the optical path may be ignored by the use of narrow-band light or narrow-band optical filters. However, focus aberrations such as coma, astigmatism, misaligned lenses, and flat versus curved field lenses, must be corrected optically.

One or more wavelengths of light may be selected on the basis of available light power, sensor sensitivity, available optical elements, optimizing signal-to-noise, safety, visibility or invisibility, interference from sunlight or artificial light, scattering in air, or other factors.

FIG. 1 also shown a connector 104. Such a connector might provide power input, control input, or data output. Such a connector is optional. For example, the device maybe battery operated and wireless communications.

Electronic circuitry converts the illumination intensity and time-of-flight information from the pixel-array image sensor 106 into a 3D point-cloud. Some or all of such circuitry may be in the image sensor 106, external to the image sensor but internal to the device, such as processor or controller on the circuit board 105, or may be external to the 103. While most embodiments describe an output of a, “three-dimensional point cloud,” such embodiments may be interpreted to mean, and alternative embodiments are specifically claimed, wherein data from the pixel-array image sensor may require external electronic or data processing to create a desired data-format. Such processing may be external to the device. A “three-dimensional point cloud” may comprise data that is capable of being transformed into a three-dimensional point cloud of a desired format without additional mechanical or optical elements. Calibration data and transformation factors may be stored internally in the device, such as in non-transitory memory on circuit board 105, or may be stored external to the device. The device has a controller, not shown, such as a processor on circuit board 105.

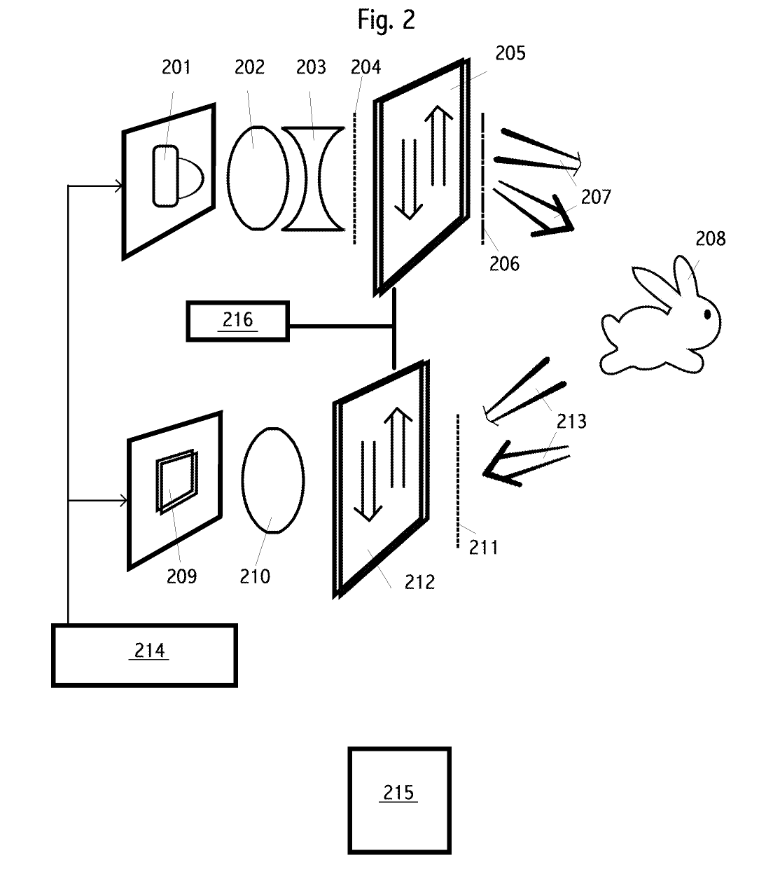

Turning now to FIG. 2, we see a schematic view of an embodiment of light paths. Please refer to descriptions above for elements shown in FIG. 1. A light source 201 is modulated by a modulator 214. An exemplary illumination optical path is from the light source 201 through a collimator 202, through a beam spreader 203, through a spectral filter 204, through a pair of illumination Risley prisms 205, through a diffuser 206, creating, via motions of the Risley prisms 205, a set of nominally contiguous reduced fields of view, 207. External to the device, light from the illumination optical path reflects off an object of interest 208, and then returns to the device's imaging optical path. 213 shows a representation of matching, or synchronized reduced fields of view for the received light by the imaging Risley prisms 212. The received light may pass first through a window or filter 211. Each reduced field of view 213 then passes through a focus lens 201 to a pixel-array image sensor 209 that also comprises time-of-flight (ToF) capability. Received light is synchronously demodulated from signals from modulator source 214. Some or all of the modulator 214 may be inside of chip 209. The pair of illumination Risley prisms 205 is driven simultaneously with the pair of imaging Risley prisms 212 via prism motors 216, such that the illumination reduced fields of view 207 match the reduced fields of view, subject to limitations, interpretations, and embodiments described elsewhere herein. The device is controlled by a controller 215, which may internal to the device, external, or a combination. Note that some optical elements shown are optional; additional optical elements may be in optical paths; optical elements may be combined, or split into multiple elements; calibration and alignment elements are not shown. Optical paths may be folded.

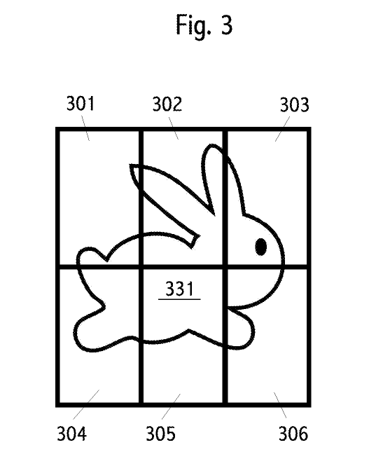

Turning now to FIG. 3, we see a simplified representation of multiple fields of view. An object of interest is shown 331. The total field of view comprises six contiguous reduced fields of view, 301 through 306. The arrangement shown may be described as 3 by 2. A suitable number of reduced fields of view is in the range of six to 600. Another suitable range is 20 to 150. Another suitable number is 40, arranged as five rows of eight. This figure shows reduced fields of view as rectangles. Ideally, reduced fields of view are square, but many other shapes are possible. This figure shows reduced fields of view arranged in a grid, but other patterns are possible, such as a hexagonal array, or any arbitrary arrangement. A novelty of this invention is the ability to place reduced fields of view anywhere within the total field of view.

A novel feature of embodiments is the ability to image any reduced field of view at an arbitrary time, and thus scan through multiple fields of view in any order. In addition, a novel feature is the ability to use different operating parameters for different fields of view. For example, a lower modulation frequency or longer dwell time (effectively: exposure time or light integration time) to achieve a longer maximum range. As another example, pixels in the pixel-array image sensor may be grouped into sets, permitting higher sensitivity at the expense of lower point resolution

This Figures shows six reduced fields of view as contiguous and perfectly aligned. As discussed elsewhere herein, such perfection is not possible in practice. Therefore, embodiments include overlapping reduced fields of view.

### Notes on Claims

Claim numbers refer to claim numbers as filed, or amended.

Specifically claimed is any combination of features described in this specification, in claims, or in drawings.

Claimed embodiments include a limitation of a, “fixed reduced field of view,” a separate limitation of a, “fixed field view and a variable total field of view, ” and a separate limitation of a, “overlapping reduced fields of view.”

Claimed embodiments include a color, color range, spectral range, or color metric, as a parameter of points in a 3D point cloud, wherein color is determined by features described herein. Color sensitivity may be dynamic for reduced fields of view, total field of view, segments of a reduced field of view, or groups of pixels. Claimed embodiments combine processing using both color as detected by an optical camera and color detected by embodiments otherwise disclosed. For example, color may be first detected by an optical camera and then hardware disclosed herein configured to detect such a color or color of an object of interest. Or, color may be first detected by hardware disclosed herein and this information then used in conjunction with color from an optical camera; such as may be used to correlate objects of interest detect by such each separate hardware.

Claimed embodiments include: “the number of non-overlapping reduced fields of view within the total field of view is in the range of 4 to 40 inclusive;” and, “the number of non-overlapping reduced fields of view within the total field of view is in the range of 6 to 600 inclusive; ” and “a maximum permissible exposure (MPE) of irradiated power, from the optical imaging system, to a human eye within the total field of view, does not exceed 2.5×10\hat{0}−3 watts/cm\hat{0}2.”

A claimed embodiment includes:
The optical imaging system of claim 1 further comprising:
an illumination spectral filter in the illumination light path;
an imaging spectral filter in the imaging light path;
wherein a pass band of the illumination spectral filter overlaps with a pass band of the imaging spectral filter.

A claimed embodiment includes:
The optical imaging system of claim 1 wherein
the first reduced field of view comprises a reduced horizontal width field of view and a reduced height vertical field of view; and
the second reduced field of view comprises the reduced horizontal width field of view and the reduced vertical field of view; and
the first and second reduced fields of view are each arbitrary reduced fields of view within the total field of view and are not the same reduced field of view; and
the reduced horizontal width field of view and the reduced vertical height field of view are fixed and predetermined, and each are more than one degree.

A claimed embodiment includes:
A system of optical ranging using the device of claim 1 (as filed) further comprising:
a human associated with the device of claim 1;
wherein operation of the device of claim 1 assists in the safety, security or identification of the human.

### Exemplary Characteristics

An image sensor may use CMOS, photodiodes, CCD technology or other light sensing technology.

Herein is described only one non-limiting embodiment

Some embodiments incorporate the following:
Usable distance of 200 meters, or better
Angular resolution of 0.1°, or less; ideally 0.015°
Field of view of 100° horizontal by 30° vertical, or larger
Coverage of entire field of view in 1 second or less, such as 0.2 seconds
Acceptable S/N with 10% reflectivity of the object imaged
Exemplary sensor: epc611 or epc660 by Espros Photonics AG (St. Gallerstrasse 135, CH-7320 Sargans, SWITZERLAND)

### Incorporation of Matter in a Provisional Application

This application incorporates by reference all matter in the above named US provisional application, including:
beam divergence angle of 0.015 degrees
320×240 QVGA 2D pixel-array image sensor with ToF
range of 100 meters
two stepper motors to drive Risley prisms using plastic gears
eye-safe irradiance intensity at the fovea of 150 watts/meter-squared
at a range of 200 meters, with a 4 degree beam spread, a single pixel is 35×35 cm,
illumination power is +31.4 dBm; −9.6 dBm at a target, and −95.6 dBm at the receive chip.
with a 4 degree lens, a ToF embodiment has 0.1 degree resolution, or 40 pixels per 4°
940 nm frequency provides #6 dBm, 4 times less interfering sunlight
a lateral camera provides course stereo distance measurement to increase range of device, and resolve ambiguity due to time of flight exceeding one modulation cycle.
lateral camera may be located to the side of an embodiment, with respect to a target
a three degree beam step; 5 frames×40 ms each, 150 ms scan time, 26 ms shutter (dwell); resolution of 0.015 degrees, or 2.6 cm at 100 meters. At 200 meters, resolution of 0.05 degrees
5 frames a 5 ms each =25 ms scan time; 1 ms shutter; 5% reflectivity, +3 dB “flash, operating as a short term, “high beam.”
An LCoS (liquid crystal on silicon) embodiment for the illumination subsystem comprises:
   a modulated, collimated light source hitting an optional 2D or 1D MEMs mirror, then to
   an optional fixed mirror or prism for folded optics; then to
   an LCoS addressable polarity switching spatial mirror, that addressably and programmably, has elements that that either change or do not change the polarization of reflected light, with a range of addressable elements such as 2×4
   an optional MEMS mirror may select one “bank” of LCos elements such as a bank of 1×4 or another bank of 1×4
   a polarization selective mirror, such as wire grid on glass
   a variable number of optical bounces between the LCoS and the polarization selective mirror, in the range of zero to four bounces, as determined by which elements of the LCoS are turned on, and optionally by the orientation of the MEMS, then to
   a segmented lens array such as four segments or a eight segments arranged as 2×4, with an exemplary pitch of 1 mm
   number of segments in the segmented mirror matches the number of selectable bounces; that each, for each possible light path there is on segment of the segmented lens used in the light path, then to
   a large, aperture lens, then
   exits the device as the illumination beam, subtending a reduced field of view.
   the imaging system is similar, but the optical path is reversed with an image sensor with ToF at the end of the imaging optical path
   segments selected in the LCoS are the same for the illumination path and the imaging path
   MEMS orientation, if used, is the same for the illumination path and the imaging path

### Definitions

Ambiguous v. unambiguous distance—Objects that are farther away than the distance corresponding to the time of flight of one cycle of the modulation frequency produce an ambiguous distance. Disambiguation is the process of identifying in which of several distance “bins” the object resides.

Risley prism—Risley prisms are well known in the art. They usually comprise a pair of optical wedges, plus a means to allow rotation of each wedge individually. However, terminology in the art is not consistent. Sometimes, “a Risley prism” refers to the pair of optical wedges. Other times, each wedge is referred to as, “a Risley prism;” which is our preferred terminology, herein. However, selecting which interpretation should be used is context dependent and a reader must careful to identify the correct interpretation.

“Prior art,” including in drawings, does NOT admit to verbatim prior art, but rather there may aspects of an element that are known in the prior art. The actual similar or corresponding element in an embodiment may or may not consist of the prior art. In many embodiment the so identified “prior art” may require extensive or non-obvious modification or additions.

Use of the word, “invention” means “embodiment,” including in drawings.

Ideal, Ideally, Optimum and Preferred—Use of the words, “ideal,” “ideally,” “optimum,” “optimum,” “should” and “preferred,” when used in the context of describing this invention, refer specifically to a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

All numerical ranges in the specification are non-limiting examples only.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substitution thereof to any and all other device claims, including all combinations of elements in device claims.

What is claimed is:

1. An optical imaging system comprising:
an illumination subsystem comprising;
a continuous wave light source;
a first pair of Risley prisms, wherein each prism is independently rotatable;
a light modulator adapted to modulate the continuous wave light source;
an imaging subsystem comprising;
a two-dimensional (2D) pixel-array light sensor comprising a time-of-flight output;
a second pair of Risley prisms, wherein each prism is independently rotatable; wherein the angular position of each of the second pair of Risley prisms matches the respective angular position of each of the first pair of Risley prisms;
a light demodulator, wherein the light demodulator is synchronous with the light modulator;
wherein each of the pair of Risley prisms comprises a matching total field of view (FoV); wherein the total field of view comprises a total horizontal field of view and a total vertical field of view;
wherein a first stopped position of the two pairs of Risley prisms provides the light sensor with a first reduced field of view within the total field of view;
wherein a second stopped position of the two pairs of Risley prisms provides the light sensor with a second reduced field of view within total field of view;
wherein the first field of view does not overlap the second field of view;
wherein a total number of reduced fields of view is three or more;
wherein changing from the first stopped position to the second stopped position is at an arbitrary, dynamically selectable time;
a set of prism motors operatively connected to the prisms; wherein the set of prism motors rotate the prisms;
a controller operatively connected to the set of prism motors and the light sensor;
wherein the optical imaging system outputs a three-dimensional point cloud comprising points within at least one reduced field of view.

2. The optical imaging system of claim 1 wherein:
the first and second reduced fields of view are each arbitrary, dynamically selectable reduced fields of view within the total field of view.

3. The optical imaging system of claim 1 wherein:
the first reduced field of view comprises a reduced horizontal width field of view and a reduced height vertical field of view; and
the second reduced field of view comprises the reduced horizontal width field of view and the reduced vertical field of view; and
the first and second reduced fields of view are each arbitrary reduced fields of view within the total field of view and are not the same reduced field of view.

4. The optical imaging system of claim 1 wherein:
a time delay between the first stopped position and the second stopped position of the two pairs of Risley prisms is an arbitrary, dynamically selectable time greater than a predetermined minimum move time.

5. The optical imaging system of claim 1 wherein:
a length of time the two pairs of Risley prisms remain in the first stopped position, a dwell time, is greater than zero and is dynamically selectable.

6. The optical imaging system of claim 1 wherein:
the number of non-overlapping reduced fields of view within the total field of view is in the range of 2 to 40 inclusive.

7. The optical imaging system of claim 1 wherein:
the light sensor comprises at least 8,000 simultaneously operable light receptors, each with a separate time-of-flight detection.

8. The optical imaging system of claim 1 wherein:
a plurality of points in the three-dimensional point cloud represent, for each point, a relative position and distance from the optical imaging system to a corresponding point on an object within the total field of view.

9. The optical imaging system of claim 1 wherein:
a plurality of points in the three-dimensional point cloud represent, for each point:
(i) a relative position and distance from the optical imaging system to a point on an object within the total field of view, and (ii) a relative reflective brightness of the point on the object.

10. The optical imaging system The method of claim 1 wherein:
a plurality of points in the three-dimensional point cloud represent, for each point, either exclusively: (A) a relative position and distance from the optical imaging system to a point on an object within the total field of view, or (B) an indication of “no usable distance;” wherein neither elements (A) nor (B) limit other attributes associated with one or more points in the three-dimensional point cloud, except as above.

11. The optical imaging system of claim 1 wherein:
a maximum permissible exposure (MPE) of irradiated power, from the optical imaging system, to a human eye within the total field of view, does not exceed the limits set by ANSI Z136.1-1993, for 0.25 second.

12. The optical imaging system of claim 1 further comprising:
an illumination light path from the continuous wave light source through a light collimator, then through the first pair of Risley prisms toward a first object;
an imaging light path from the first object, through the second pair of Risley prisms, then through a focus lens to the light sensor.

13. The optical imaging system of claim 1 further comprising:
an engineered diffuser in the illumination light path;
wherein the engineered diffuser is adapted to provide a beam divergence of a predetermined beam divergence angle.

14. A method of optical ranging using the device of claim 1 comprising the steps:
(a) moving both pairs of Risley prisms to a first reduced field of view;
(b) illuminating the first reduced field of view with modulated continuous wave light;
(c) imaging at once, using the light sensor, reflected light from objects in the first reduced field of view, and simultaneously detecting distances;
(d) generating a first 3D point cloud with 300 or more points.

15. The method of optical ranging of claim 14 comprising the additional steps:
(e) moving both pairs of Risley prisms to a second, arbitrary, reduced field of view,
(f) illuminating the second reduced field of view with modulated continuous wave light;
(g) imaging at once, using the light sensor, reflected light from objects in the second reduced field of view, and simultaneously detecting distances;
(h) generating a second 3D point cloud with 300 or more points.

16. The method of optical ranging of claim 14 comprising the additional steps:
(i) moving both pairs of Risley prisms to a second, arbitrary, reduced field of view,
(j) illuminating the second reduced field of view with modulated continuous wave light;
(k) imaging at once, using the light sensor, reflected light from objects in the second reduced field of view, and simultaneously detecting distances;
(l) generating a second 3D point cloud with 300 points or more points;
(m) repeating steps (j) though (l) repetitively until the entire total field of view has been covered by the reduced fields of view.

17. The method of optical ranging of claim 14 comprising the additional steps:
(n) moving both pairs of Risley prisms to a second, arbitrary, reduced field of view,
(o) illuminating the second reduced field of view with modulated continuous wave light;
(p) imaging at once, using the light sensor, reflected light from objects in the second reduced field of view, and simultaneously detecting distances;
(q) generating a second 3D point cloud with 300 points or more points;
(r) wherein the modulation frequency is altered and a dwell time is altered for steps (o) and (p), with respect to modulation frequency and a dwell time for steps (b) and (c).

18. The method of optical ranging of claim 14 wherein:
steps (a) through (d) identify an object of interest with an ambiguous distance;
and the additional step:
(s) eliminating a distance ambiguity by the use of an optical camera and image processing software.

19. The method of optical ranging of claim 14 comprising the additional steps:
(t) identifying an object of interest in the total field of view;
(u) comparing two or more locations of the object of interest in a series of steps (a), (b), and (c);
(v) computing a velocity of the object of interest responsive to the comparing.

20. The method of optical ranging of claim 14 comprising the additional steps:
(w) repeating steps (a) through (d);
(x) detecting an object of interest wherein a portion of the object of interest is in at least two reduced fields of view;
(y) identifying the object of interest using an image by the use of an optical camera and image processing software.

21. A system of optical ranging using the device of claim 1 further comprising:
a vehicle comprising the device of claim 1;
wherein operation of the device of claim 1 assists in the operation of the vehicle.
